(19) United States
(12) Patent Application Publication
(10) Pub. No.: US 2020/0011392 A1
(43) Pub. Date: Jan. 9, 2020

(54) WAVE SPRING

(71) Applicant: NHK SPRING Co., Ltd., Kanagawa (JP)

(72) Inventor: Hideaki SAKAI, Yokohama-shi (JP)

(21) Appl. No.: 16/491,018

(22) PCT Filed: Mar. 8, 2018
(86) PCT No.: PCT/JP2018/008957

§ 371 Date: Sep. 4, 2019

(30) Foreign Application Priority Data
Mar. 8, 2017 (JP) 2017-044390

(51) Int. Cl. F16F 1/32

(52) U.S. Cl. CPC F16F 1/328; F16D 25/0638

(57) ABSTRACT

The wave spring includes an annular body formed by alternately connecting a convex portion and a concave portion in a circumferential direction, wherein the annular body is provided with a notch.

### CROSS REFERENCE TO RELATED APPLICATIONS

This is the U.S. national stage of application No. PCT/JP2018/008957, filed on Mar. 8, 2018. Priority under 35 U.S.C. § 119(a) and 35 U.S.C. § 365(b) is claimed from Japanese Application No. 2017-044390, filed Mar. 8, 2017; the disclosures of which are incorporated herein by reference.

### TECHNICAL FIELD

The present invention relates to a wave spring.

Priority is claimed on Japanese Patent Application No. 2017-044390, filed Mar. 8, 2017, the content of which is incorporated herein by reference.

### BACKGROUND

In general, a wave spring includes an annular body formed by alternately connecting convex portions and concave portions in a circumferential direction. For example, Patent Document 1 described below shows that the load of the wave spring is adjusted by changing the height or the number of the convex portions and the concave portions, or the material or the plate thickness of the wave spring. It is also generally known to adjust the load of the wave spring by changing the inner diameter or the outer diameter of the annular body.

### DOCUMENT OF RELATED ART

### Patent Document

[Patent Document 1] Japanese Unexamined Patent Application, First Publication No. 2005-282807

### SUMMARY

### Technical Problem

Incidentally, this kind of wave spring is generally arranged to be interposed between two components, and the convex portion or the concave portion of the annular body comes into contact with these components, thereby generating a load. Therefore, if the height of the convex portion and the concave portion or the plate thickness of the wave spring is changed, the stroke amount thereof in a state of being interposed between the opposing components also changes.

Further, in many cases, this type of wave spring is used in a state of being fitted on a shaft or of being housed inside a cylinder. Therefore, the inner diameter or the outer diameter of the annular body may be restricted by the positional relationship with the opposing component and thus may not be changed.

From the above, the wave spring is easily subject to design restrictions in relation to the opposing component, and it may be difficult to obtain desired load characteristics.

The present invention is made in view of such circumstances, and an object thereof is to improve the design flexibility of the wave spring.

### Solution to Problem

In order to solve the above problems, a wave spring of an aspect of the present invention includes an annular body formed by alternately connecting a convex portion and a concave portion in a circumferential direction, wherein the annular body is provided with a notch.

In the wave spring of the above aspect, the annular body is provided with the notch. The load characteristics of the wave spring can be easily adjusted by changing the configuration of the notch such as the arranged position, the quantity, the size or the like. Changing the configuration of the notch in this way is hard to be restricted by the opposing component compared to a case of changing the outer diameter or the inner diameter of the wave spring, the height of the convex portion or the concave portion, or the like. Therefore, the design flexibility of the wave spring can be improved by changing the configuration of the notch to adjust the load characteristics.

In addition, in the wave spring of the above aspect, the end in the circumferential direction of the notch may be positioned at a portion other than peak parts of the convex portion and the concave portion.

In this case, the end in the circumferential direction of the notch is positioned at a portion of the wave spring other than the peak parts of the convex portion and the concave portion on which stress tends to concentrate, and thus the deterioration in the strength of the wave spring by high stress acting on the end can be limited.

Further, in the wave spring of the above aspect, a plurality of the notches may be provided in the annular body at intervals in the circumferential direction, and the separation in the circumferential direction between the notches adjacent to each other in the circumferential direction may be greater than the width in the circumferential direction of the notch.

In the wave spring of the above aspect, the notch may be recessed inward in a radial direction from an outer peripheral surface of the annular body.

In the wave spring, relatively higher stress acts on the inner peripheral side than on the outer peripheral side thereof. Therefore, by providing the notch on the outer peripheral surface, for example, compared to a case where the notch is provided on the inner peripheral surface, the deterioration in the strength of the wave spring by high stress acting on the periphery of the notch can be limited.

The wave spring of the above aspect may include a rotation restriction part protruding outward in a radial direction from an outer peripheral surface of the annular body.

In this case, the rotation of the wave spring can be restricted by the rotation restriction part.

### Effects

According to the above aspect of the present invention, the design flexibility of the wave spring can be improved.

### BRIEF DESCRIPTION OF DRAWINGS

FIG. 1A-FIG. 1B is a schematic diagram of a wave spring shown as an embodiment of the present invention, the part FIG. 1A thereof is a plan view, and the part FIG. 1B thereof is a cross-sectional view taken along A-A line in the part FIG. 1A.

FIG. 2 is a schematic diagram of a clutch device to which the wave spring shown in FIG. 1A-FIG. 1B is attached.

### DESCRIPTION OF EMBODIMENTS

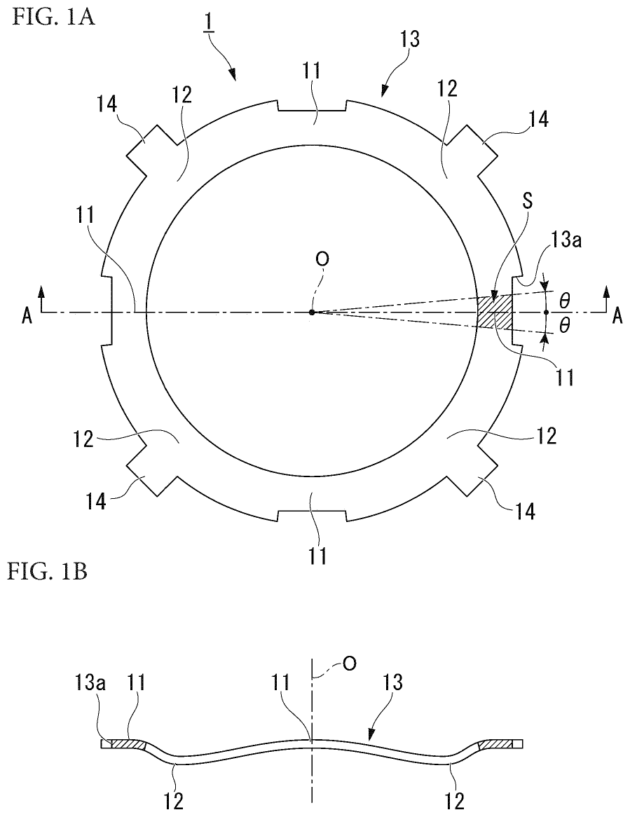

Hereinafter, an embodiment of a wave spring of the present invention will be described with reference to FIG. 1 and FIG. 1B.

As shown in FIG. 1A, a wave spring 1 of this embodiment includes an annular body 13 centering on a central axis line O. Here, in this embodiment, a direction along the central axis line O is referred to as an axial direction. In a plan view as viewed in the axial direction, a direction orthogonal to the central axis line O is referred to as a radial direction, and a direction going around the central axis line O is referred to as a circumferential direction.

The wave spring 1 is formed of a plate material such as elastically deformable metal or the like by using, for example, press working or the like, but the material and the working method of the wave spring 1 may be appropriately changed.

As shown in FIG. 1A and FIG. 1B, the annular body 13 is formed by alternately connecting, in the circumferential direction, convex portions 11 protruding toward one side in the axial direction and concave portions 12 protruding toward another side. That is, the convex portion 11 protrudes toward one of two areas between which the wave spring 1 is interposed in the axial direction, and the concave portion 12 protrudes toward the other of the two areas. The wave spring 1 includes a rotation restriction part 14 protruding outward in the radial direction from an outer peripheral surface (outer peripheral edge) of the annular body 13. A plurality of rotation restriction parts 14 are arranged on the outer peripheral surface of the annular body 13 at equal intervals in the circumferential direction. Each rotation restriction part 14 has a rectangular shape in plan view, and two sides of the four sides thereof extend in approximately the radial direction, and the other two sides extend in approximately the circumferential direction. The rotation restriction parts 14 and the annular body 13 are plate bodies having an equal thickness. The annular body 13 and the rotation restriction parts 14 are integrally formed, and the front surfaces thereof facing in the axial direction are connected with no step, and the back surfaces thereof facing in the axial direction are connected with no step. The size (width) in the circumferential direction of the rotation restriction part 14 is equal on the entire area thereof in the radial direction.

FIG. 1A is a plan view of the wave spring 1 viewed in the axial direction, and FIG. 1B is a side view of the wave spring 1 viewed in the radial direction.

In addition, the annular body 13 and the rotation restriction parts 14 may be formed in separate members and may be joined together. The rotation restriction part 14 is not limited to a plate body, and may be appropriately changed to, for example, a block body. The boundary between the front surfaces of the annular body 13 and the rotation restriction part 14 or between the back surfaces thereof may be provided with a step. For example, the size in the circumferential direction of the rotation restriction part 14 may be gradually decreased or increased outward in the radial direction.

Next, a clutch device 30 to which the wave spring 1 is attached will be described. The configuration not shown is similar to the related art and thus is omitted hereafter.

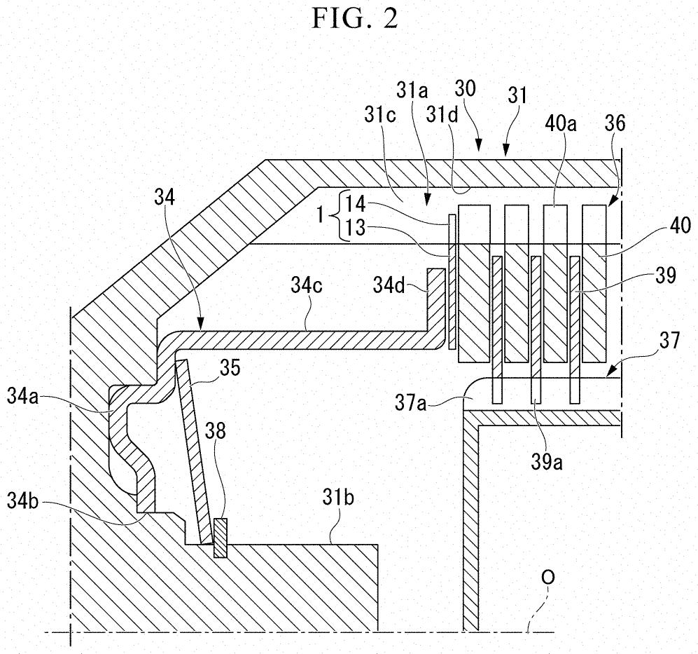

As shown in FIG. 2, the clutch device 30 includes a case body (clutch drum) 31, a cylindrical piston 34, an annular return spring 35, a friction mechanism 36, the wave spring 1, a clutch hub 37 and a snap ring 38.

Among these members, the members 1, 34 to 38 other than the case body 31 are accommodated inside the case body 31. The piston 34, the return spring 35, the friction mechanism 36, the clutch hub 37 and the snap ring 38 are arranged coaxially with the wave spring 1.

The case body 31 is formed of, for example, an aluminum alloy or the like.

The piston 34 is formed in a laterally extending cylindrical shape with a bottom. A bottom wall part 34a of the piston 34 is provided with a through-hole 34b positioned coaxially with the central axis line O, and a support protrusion 31b provided in the case body 31 is disposed inside the through-hole 34b. An open end part 34d of a circumferential wall part 34c of the piston 34 faces the friction mechanism 36 in the axial direction. The return spring 35 and the snap ring 38 are arranged inside the circumferential wall part 34c of the piston 34 in this order in the axial direction from the bottom wall part 34a-side to the open end part 34d-side.

An inner peripheral part of the snap ring 38 is fixed to the support protrusion 31b, and an outer peripheral part of the snap ring 38 supports an inner peripheral part of the return spring 35 from the open end part 34d-side in the axial direction.

The return spring 35 is fitted on the support protrusion 31b from the outside. An outer peripheral part of the return spring 35 is in contact with an inner surface of the piston 34.

The wave spring 1 is disposed in a gap in the axial direction between the open end part 34d of the circumferential wall part 34c of the piston 34 and the friction mechanism 36. The rotation restriction part 14 of the wave spring 1 is engaged with a recessed part 31a formed on an inner surface of the case body 31. Thereby, the rotation of the wave spring 1 around the central axis line O with respect to the case body 31 is restricted.

In the above configuration, when the piston 34 moves to the open end part 34d-side (right side in FIG. 2) in the axial direction, the piston 34 pushes and elastically deforms the return spring 35 and the wave spring 1. Among these members, the return spring 35 causes the piston 34 to restoratively move in the axial direction, and the wave spring 1 moderates the impact force that occurs when the piston 34 comes into contact with the friction mechanism 36.

The friction mechanism 36 is disposed to face the open end part 34d of the piston 34 from the outside of the piston 34 in the axial direction. The friction mechanism 36 is configured in which annular follower plates 40 and annular friction plates 39 whose inner diameter and outer diameter are less than those of the follower plate 40 respectively are arranged alternately in the axial direction. The follower plates 40 and the friction plates 39 are arranged coaxially with the central axis line O. An outer restriction protrusion 40a that protrudes outward in the radial direction is provided on the outer peripheral surface of the follower plate 40. An inner restriction protrusion 39a that protrudes inward in the radial direction is provided on the inner peripheral surface of the friction plate 39.

The outer restriction protrusion 40a of the follower plate 40 is engaged with the recessed part 31a of the case body 31.

The recessed part 31a is formed in a groove shape, which extends in the axial direction and opens inward in the radial direction. The recessed part 31a has a rectangular shape when viewed in the axial direction, and two sides of the four sides of the recessed part 31a extend substantially in the radial direction. Three inner surfaces 31c and 31d that form the recessed part 31a extend straight in the axial direction. Among the inner surfaces 31c and 31d that form the recessed part 31a, a pair of facing surfaces 31c that are opposite to each other in the circumferential direction face circumferential end surfaces (a pair of end surfaces in the circumferential direction) of the restriction protrusion 14 in the circumferential direction. The inner surface 31d faces inward in the radial direction.

The clutch hub 37 is arranged at the inside in the radial direction of the friction mechanism 36. The outer peripheral surface of the clutch hub 37 is provided with an engagement recess 37a with which the inner restriction protrusion 39a of the friction plate 39 engages.

Incidentally, as described above, the wave spring 1 is housed in the case body 31 and is disposed in the gap between the piston 34 and the friction mechanism 36. Therefore, when the shape or size of the wave spring 1 is changed, the consideration is required for preventing the wave spring 1 from contacting members in the vicinity of the wave spring 1 or for preventing a gap between the wave spring 1 and members in the vicinity thereof from extremely increasing. Therefore, in order to adjust the load characteristics of the wave spring 1, for example, even if the inner diameter or the outer diameter of the annular body 13 is tried to be changed, such a change may not be performed due to the relationship with the opposing component. In addition, for example, if the height of the convex portion 11 and the concave portion 12 or the plate thickness of the wave spring 1 is changed, the stroke amount of the wave spring 1 in a state of being interposed between the piston 34 and the friction mechanism 36 also changes. Therefore, the height of the convex portion 11 and the concave portion 12 or the plate thickness of the wave spring 1 may not be changed. In this way, the wave spring 1 is easily subject to design restrictions in relation to the opposing component, and it may be difficult to obtain the desired load characteristics.

Therefore, in the wave spring 1 of this embodiment, as shown in FIG. 1A, the annular body 13 is provided with a notch 13a. The notch 13a is recessed inward in the radial direction from the outer peripheral surface of the annular body 13. The depth in the radial direction of the notch 13a is less than or equal to half the width in the radial direction of the annular body 13. The width in the circumferential direction of the notch 13a is greater than the width in the circumferential direction of the rotation restriction part 14. A plurality of notches 13a are formed on the outer peripheral surface of the annular body 13 at equal intervals in the circumferential direction. The separation in the circumferential direction between the notches 13a adjacent to each other in the circumferential direction is greater than the width in the circumferential direction of the notch 13a. Each notch 13a is positioned between the rotation restriction parts 14 adjacent to each other, in the circumferential direction. In the example shown in the diagram, each notch 13a extends from the peak part of the convex portion 11 of the annular body 13 toward both sides of the peak part in the circumferential direction. That is, the peak part of the convex portion 11 of the annular body 13 is positioned between the ends in the circumferential direction of each notch 13a. Here, the end in the circumferential direction of each notch 13a is positioned between the peak part of the convex portion 11 and the peak part of the concave portion 12. Thereby, the end in the circumferential direction of each notch 13a is positioned at a portion of the annular body 13 other than the peak parts of the convex portion 11 and the concave portion 12. Further, the center part in the circumferential direction of the notch 13a is arranged at a position equal in the circumferential direction to the peak part of the convex portion 11 of the annular body 13. The shape of the annular body 13 including the notches 13a is point-symmetric around the central axis line O in plan view.

In the wave spring 1 of this embodiment, it is possible to change the configuration of the notch 13a such as the arranged position, the quantity, the size or the like. Therefore, the load characteristics of the wave spring 1 can be easily adjusted. Changing the configuration of the notch 13a in this way is hard to be subject to restrictions by the opposing component compared to a case of changing the outer diameter or the inner diameter of the wave spring 1, the height of the convex portion 11 or the concave portion 12, or the like. Therefore, the design flexibility of the wave spring 1 can be improved by changing the configuration of the notch 13a to adjust the load characteristics.

When the wave spring 1 is elastically deformed, stress tends to concentrate on the peak parts of the convex portion 11 and the concave portion 12. Therefore, in this embodiment, the end in the circumferential direction of the notch 13a is positioned at a portion other than the peak parts of the convex portion 11 and the concave portion 12. Thereby, the deterioration in the strength of the wave spring 1 by high stress acting on the end in the circumferential direction of the notch 13a can be limited. In one example, it is sufficient that the end in the circumferential direction of the notch 13a is at a position (outside of the shaded part S in FIG. 1A) away from each peak part of the convex portion 11 and the concave portion 12 at an angle θ or more around the central axis line O in plan view. When the number of pairs of the convex portions 11 and the concave portions 12 included in the wave spring 1 is represented by N, the angle θ is defined by θ=N/2. In the example of FIG. 1A, since the number N of pairs of the convex portions 11 and the concave portions 12 is 4, the angle θ is 2°.

Further, when the wave spring 1 is elastically deformed, relatively higher stress acts on the inner peripheral side than on the outer peripheral side thereof. Therefore, in this embodiment, the notch 13a is provided so as to be recessed inward in the radial direction from the outer peripheral surface of the annular body 13. Thereby, for example, compared to a case where the notch 13a is provided on the inner peripheral surface of the annular body 13, the deterioration in the strength of the wave spring 1 by high stress acting on the periphery of the notch 13a can be limited.

Note that the technical scope of the present invention is not limited to the above-described embodiment, and various modifications can be added within the scope of the present invention.

For example, in the above embodiment, the rotation restriction part 14 is provided on the outer peripheral side of the annular body 13, but the present invention is not limited thereto. For example, the rotation of the wave spring 1 may be restricted by a rotation restriction part protruding inward in the radial direction from the inner peripheral surface of the annular body 13.

In addition, the notch 13a may be arranged on the inner peripheral side of the annular body 13. In this case, the notch 13a may be recessed outward in the radial direction from the inner peripheral surface of the annular body 13.

Further, a plurality of rotation restriction parts 14 may be arranged on the outer peripheral surface or the inner peripheral surface of the annular body 13 at uneven intervals in the circumferential direction.

Moreover, it is possible to appropriately replace the constituent elements of the above-described embodiments with well-known constituent elements within the scope of the present invention, and the above-described embodiments and modifications may be appropriately combined.

### DESCRIPTION OF REFERENCE SIGNS

1 wave spring
11 convex portion
12 concave portion
13 annular body
13a notch
14 rotation restriction part
O central axis line

What is claimed is:

1. A wave spring comprising:
an annular body formed by alternately connecting a convex portion and a concave portion in a circumferential direction, wherein
the annular body is provided with a notch.

2. The wave spring according to claim 1, wherein an end in the circumferential direction of the notch is positioned at a portion other than peak parts of the convex portion and the concave portion.

3. The wave spring according to claim 2, wherein a plurality of the notches are provided in the annular body at intervals in the circumferential direction, and
a separation in the circumferential direction between the notches adjacent to each other in the circumferential direction is greater than a width in the circumferential direction of the notch.

4. The wave spring according to claim 1, wherein the notch is recessed inward in a radial direction from an outer peripheral surface of the annular body.

5. The wave spring according to claim 1, further comprising:
a rotation restriction part protruding outward in a radial direction from an outer peripheral surface of the annular body.
